(19) United States
(12) Patent Application Publication
(10) Pub. No.: US 2026/0099447 A1
(43) Pub. Date: Apr. 9, 2026

(54) PREFETCHING PORTIONS OF LARGE LANGUAGE MODELS

(71) Applicant: Samsung Electronics Co., Ltd., Suwon-si (KR)

(72) Inventors: Usman SAJID, San Jose, CA (US); Marie Mai NGUYEN, Pittsburgh, PA (US); Shuyi PEI, Santa Clara, CA (US); Younghoon KIM, San Diego, CA (US); Rekha PITCHUMANI, Herndon, VA (US)

(21) Appl. No.: 19/326,681

(22) Filed: Sep. 11, 2025

Related U.S. Application Data
(60) Provisional application No. 63/703,896, filed on Oct. 4, 2024.

(51) Int. Cl. G06F 12/0862; G06F 40/284; G06N 3/08

(52) U.S. Cl. CPC G06F 12/0862; G06F 40/284; G06N 3/08

(57) ABSTRACT

Prefetching portions of large language models is disclosed. A token computed based on a user input to a generative large language model may be received. A portion of the generative large language model may be identified using the token and a machine learning model trained to identify portions of the generative large language model. The portion may be written into a memory. The generative large language model may be caused to generate an output based on the user input using the portion in the memory.

### RELATED APPLICATION DATA

This application claims the benefit of U.S. Provisional Patent Application Ser. No. 63/703,896, filed Oct. 4, 2024, which is incorporated by reference herein for all purposes.

### FIELD

The disclosure relates generally to large language models, and more particularly to prefetching portions of large language models.

### BACKGROUND

Compute resources and memory resources are utilized differently for different applications. Some applications such as machine learning applications include first operations that consume substantial compute resources and second operations that consume substantial memory resources. Performance of the first and second operations within these applications may be limited based on compute resources, memory resources, or both.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 illustrates a system including a generative large language model, according to embodiments of the disclosure.

FIG. 2 illustrates a memory die of a memory device, according to embodiments of the disclosure.

FIG. 3 illustrates a base die of a memory device, according to embodiments of the disclosure.

FIG. 4 illustrates a processing circuit, according to embodiments of the disclosure.

FIG. 5 illustrates an example of a first set of resources, according to embodiments of the disclosure.

FIG. 6 illustrates an example of a second set of resources, according to embodiments of the disclosure.

FIG. 7 illustrates a representation of tokens computed based on a user input to a generative large language model, according to embodiments of the disclosure.

FIGS. 8A and 8B illustrate examples of identifying subnetworks within layers of a generative large language model, according to embodiments of the disclosure.

FIG. 9 illustrates a representation of determining potential subnetworks within layers of a generative large language model based on tokens, according to embodiments of the disclosure.

FIG. 10 illustrates a representation of generating training data, according to embodiments of the disclosure.

FIG. 11 illustrates a representation of training a machine learning model using training data, according to embodiments of the disclosure.

FIG. 12 illustrates a representation of prefetching a portion of a generative large language model, according to embodiments of the disclosure.

FIG. 13 shows a flowchart of an example procedure for causing a generative large language model to generate an output, according to embodiments of the disclosure.

FIG. 14 shows a flowchart of an example procedure for causing a generative large language model to generate an output, according to embodiments of the disclosure.

FIG. 15 shows a flowchart of an example procedure for generating an output with a generative large language model, according to embodiments of the disclosure.

### SUMMARY

A token computed based on a user input to a generative large language model may be received. A portion of the generative large language model may be identified using the token and a machine learning model trained to identify portions of the generative large language model. The portion may be written into a memory. The generative large language model may be caused to generate an output based on the user input using the portion in the memory.

A current token and at least one previous token generated based on a user input to a generative large language model may be received. Subnetworks within the generative large language model may be identified by processing the current token and the at least one previous token using a machine learning model. The subnetworks may be prefetched from a first memory into a second memory. The generative large language model may be caused to generate an output based on the user input using the subnetworks in the second memory.

A token computed based on a user input to a generative large language model may be received. Portions of layers of the generative large language model may be identified by processing the token using a machine learning model. The portions of the layers may be written into a memory. An output may be generated with the generative large language model based on the user input using the portions of the layers in the memory.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Compute resources and memory resources are utilized differently for performing different operations. Some artificial intelligence applications perform first operations that consume substantial compute resources and second operations that consume substantial memory resources. For memory intensive operations that are performed by a processor relative to specific data, there may be latency (e.g., a delay) associated with reading the specific data from a remote memory (e.g., a “slow memory”) if the specific data is not available to the processor in a local memory (e.g., a “fast memory”). In some embodiments, within a particular set of resources, the remote memory may include a low-power double data rate (LPDDR) memory accessible to a LPDDR memory controller and the local memory may include dynamic RAM (DRAM) of a memory die that is attached to a base die having one or more processing circuits.

Consider an example in which a generative large language model is implemented to generate an output based on a user input. In this example, the generative large language model processes tokens using layers of the model in iterations in order to generate the output. Each of the layers of the generative large language model may include multiple subnetworks or “experts” that each correspond to one or more different subject matter domains.

Continuing the example, only some of the subnetworks or “experts” included in a particular layer of the model are selected to process a particular token. For instance, the particular layer may include eight subnetworks and only two of the eight subnetworks are selected to process the particular token. In order to process the particular token, data describing the two selected subnetworks from the particular layer may be read from a first memory that is remote to a processor and written to a second memory that is local to the processor.

After the data describing the two selected subnetworks is written to the second memory, the processor may perform operations to process the particular token using the data included in the second memory. Notably, there may be latency (e.g., a delay) associated with reading the data describing the two selected subnetworks from the first memory that is remote to the processor before the data is available in the second memory. In order to avoid such latency, a machine learning model may be trained on training data to identify portions of the generative large language model that include selected subnetworks or “experts” from layers of the generative large language model.

Once trained, the machine learning model may be configured to receive a current token and at least one previous token generated based on a user input to the generative large language model and the machine learning model may output identified subnetworks within layers of the generative large language model based on the current token and the at least one previous token. In some embodiments, data describing the identified subnetworks within the layers of the generative large language model may be read from the first memory that is remote to the processor and written to the second memory that is local to the processor such that the data is available in the second memory when requested by the processor for the current token. By prefetching the data describing the identified subnetworks within the layers, latency can be avoided/reduced which improves an overall end-to-end efficiency of generating the output using the generative large language model.

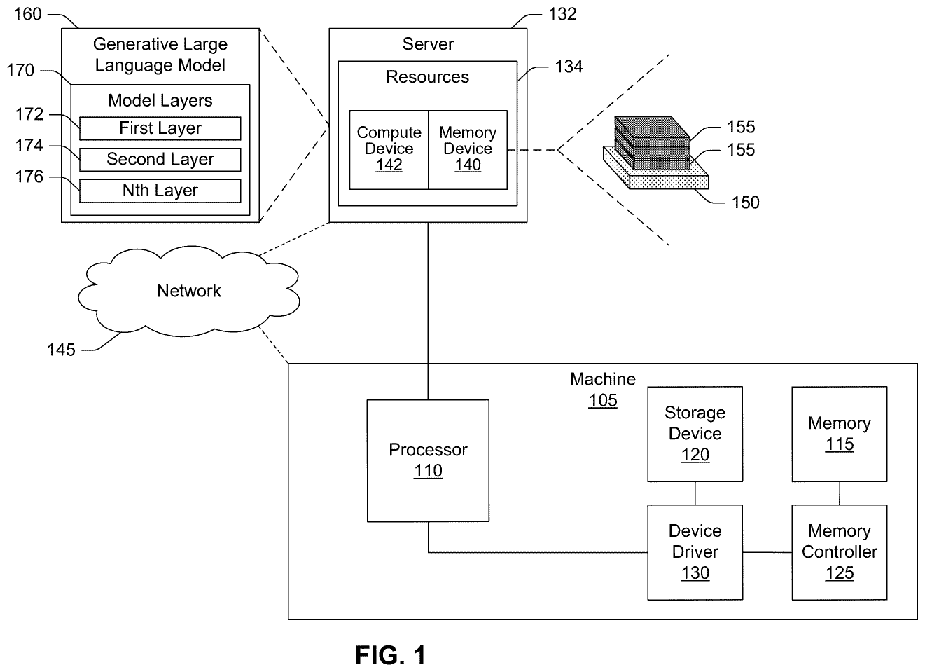

FIG. 1 illustrates a system including a generative large language model 160, according to embodiments of the disclosure. As shown in FIG. 1, a machine 105 (e.g., a host) includes a processor 110, a memory 115, and a storage device 120. The processor 110 is representative of a variety of types of processors such as central processing units (CPUs), accelerators, graphics processing units (GPUs), processors implemented using field-programmable gate arrays (FPGAs) (e.g., soft processors), etc. The memory 115 can include volatile memory and/or non-volatile memory and the memory 115 is representative of a variety of types of memory such as random access memory (RAM), static RAM (SRAM), dynamic RAM (DRAM), synchronous DRAM (SDRAM), etc.

Read/write operations performed relative to the memory 115 may be managed by a memory controller 125. In the illustrated example, the processor 110 is communicatively coupled to the memory controller 125 via a wired or wireless connection. The processor 110 is also shown to be communicatively coupled to the storage device 120 via a device driver 130. The device driver 130 can control the storage device 120 and the device driver 130 may be implemented using software, hardware, or a combination of software and hardware.

The system shown in FIG. 1 is illustrated to include a server 132 having resources 134 which may include one or more memory devices 140 and one or more compute devices 142. Although the server 132 is illustrated as a single server, it is to be appreciated that, in some embodiments, the resources 134 may be distributed across multiple servers 132. The compute devices 142 may include one or more processors such as CPUs, application specific integrated circuits (ASICs), accelerators, GPUs, neural processing units (NPUs), tensor processing units (TPUs), etc. A memory device 140 can include one or more memory die 155 having volatile memory and/or non-volatile memory. In some embodiments, the memory device 140 may include one or more memory die 155 having a variety of types of memory such as DRAM, SRAM, magnetoresistive RAM (MRAM), phase change memory (PCM), Flash, read-only memory (ROM), and/or combinations of such.

In some embodiments, compute and/or memory resources included in the memory device 140 may be physically disposed in a three-dimensional stack (e.g., to minimize distances between locations of the resources). In the example depicted in FIG. 1, the memory device 140 is illustrated to include a base die 150 and one or more memory die 155 attached to the base die 150 in a three-dimensional stack. In some embodiments, compute and/or memory resources of the memory device 140 are connected to the base die 150 and/or the memory die 155. For instance, including compute and/or memory resources of the memory device 140 in a three-dimensional stack of the memory die 155 attached to the base die 150 may minimize power consumed and physical space occupied by the compute and/or memory resources. Although examples are described with respect to the memory die 155 attached to the base die 150, it is to be appreciated that, in some embodiments, compute and/or memory resources of the memory device 140 are included in other orientations (e.g., non-stacked orientations) and configurations (e.g., integrated configurations).

In some embodiments, the resources 134 may be communicatively coupled to the machine 105 via a wired or wireless connection. By way of example, the processor 110 may be connected to the server 132 via a network 145. In the illustrated example, the resources 134 are at least partially dedicated to a generative large language model 160. As shown, the generative large language model 160 includes model layers 170 (e.g., hundreds of layers). In FIG. 1, the model layers 170 are illustrated to include a first layer 172, a second layer 174, and an Nth layer 176.

In some embodiments, the generative large language model 160 is trained on training data (e.g., corpuses of training data) to generate outputs based on user inputs or “prompts.” Typically, the generative large language model 160 is trained by one or more operators or users that prepare the training data and monitor the training. Once trained, the generative large language model 160 is capable of generating outputs within different subject matter domains. For example, the generative large language model 160 may generate a natural language output explaining a historical event based on a first user input and the generative large language model 160 may generate lines of executable code based on a second user input.

In order to generate outputs within different subject matter domains, the model layers 170 can include multiple subnetworks or “experts” having weights learned during training that correspond to one or more particular subject matter domains. For instance, the first layer 172 may include a first subnetwork that is selected to process the first user input in order to generate the natural language output explaining the historical event. Similarly, the first layer 172 can include a second subnetwork that is selected to process the second user input in order to generate the lines of executable code.

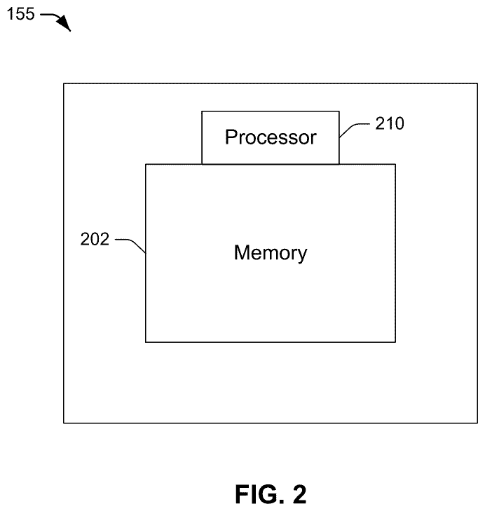

FIG. 2 illustrates a memory die 155 of a memory device 140, according to embodiments of the disclosure. As shown, a memory die 155 includes a memory 202. The memory 202 can include volatile memory and/or non-volatile memory and the memory 202 is representative of a variety of types of memory such as DRAM, SRAM, MRAM, PCM, Flash, ROM, and/or combinations of such. Accordingly, FIG. 2 depicts an example in which memory resources (e.g., the memory 202) of the memory device 140 are included in the memory die 155. In some embodiments, the memory die 155 includes one memory, two memories, more than two memories, etc. In some embodiments, the memory die 155 is a DRAM die, and the memory 202 represents DRAM.

In some optional embodiments, the memory die 155 includes a processor 210. Like the processor 110, the processor 210 is representative of a variety of types of processors such as CPUs, ASICs, accelerators, GPUs, NPUs, TPUs, etc. In the illustrated example, the processor 210 is coupled to the memory 202. Thus, FIG. 2 depicts an example in which memory resources (e.g., the memory 202) and compute resources (e.g., the processor 210) of the memory device 140 are included in the memory die 155. Although the example shown in FIG. 2 includes the processor 210, it is to be appreciated that, in some embodiments, the memory die 155 can include additional processors which may be structurally similar to the processor 210 or different from the processor 210.

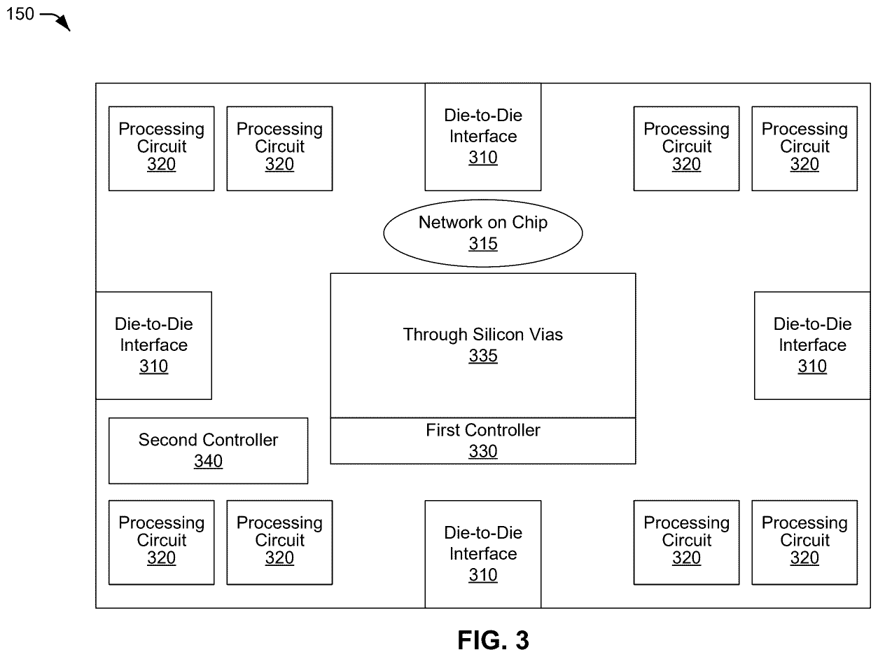

FIG. 3 illustrates a base die 150 of a memory device 140, according to embodiments of the disclosure. As shown, a base die 150 can include one or more die-to-die interfaces 310, a network on chip 315, one or more processing circuits 320, a first controller 330, through silicon vias 335, and a second controller 340. In an example in which the memory die 155 illustrated in FIG. 2 is a DRAM die, the first controller 330 may be a memory controller (e.g., a DRAM controller) configured to control the memory 202 using the through silicon vias 335.

As shown in FIG. 3, the first controller 330 can be connected to the through silicon vias 335. For instance, the through silicon vias 335 can communicatively couple (e.g., by multiple electrical connections) the memory 202 of the memory die 155 to the first controller 330 of the base die 150. In a particular example, controller logic (CTL) of the first controller 330 can issue a command to a physical interface/layer (PHY) which converts the command into a signal for transmission to the memory die 155 by the through silicon vias 335. In the particular example, the through silicon vias 335 may transmit data read from the memory 202 of the memory die 155 to the PHY and the CTL. Although FIG. 3 is illustrated to include the through silicon vias 335, it is to be appreciated that, in some embodiments, hybrid bonding (e.g., dielectric-to-dielectric connections and conductor-to-conductor connections in a stacked configuration) may be used in addition or alternative to the through silicon vias 335.

In some embodiments, the die-to-die interfaces 310 are configured to interface with one or more additional dies and/or various types of compute and/or memory resources, as described below. The die-to-die interfaces 310 are representative of multiple different types of physical interfaces which can support different interface protocols/specifications such as universal chiplet interconnect express (UCIe), bunch of wires (BOW), advanced interface bus (AIB), opensource protocols/specifications (e.g., OpenHBI), etc. Although FIG. 3 illustrates four die-to-die interfaces 310, it is to be appreciated that, in some embodiments, the base die 150 includes less than four die-to-die interfaces 310 or more than four die-to-die interfaces 310.

As shown in FIG. 3, the base die 150 includes the network on chip 315 which may be internal to the base die 150 (e.g., integrated into the base die 150). The network on chip 315 may be configured to communicatively couple various devices/components (e.g., in a network-based architecture). For instance, the network on chip 315 may be configured to interface with an accelerator link, a memory controller, etc. In some embodiments, the network on chip 315 may connect the die-to-die interfaces 310 to the processing circuits 320, the first controller 330, the second controller 340, etc. In some embodiments, the network on chip 315 may communicatively couple the processing circuits 320 to each other and/or to the second controller 340.

The processing circuits 320 include compute and/or memory resources of the base die 150 of the memory device 140. In some embodiments, compute and/or memory resources are included in the processing circuits 320 in addition or alternative to compute and/or memory resources included in the memory die 155 of the memory device 140. In some embodiments, the second controller 340 is configured to control the processing circuits 320 by controlling or triggering kernel execution by the processing circuits 320. The second controller 340 can represent or include a management CPU configured to control operations of the processing circuits 320 such as setting parameters, collecting results, transmitting commands, etc.

Although the first controller 330 and the second controller 340 are illustrated as two controllers, it is to be appreciated that, in some embodiments, the first controller 330 and the second controller 340 are implemented as a single controller. It also should be appreciated that by including the processing circuits 320 as part of the base die 150 in relatively close proximity to data (e.g., near the memory 202 of the memory die 155), the processing circuits 320 have faster access to the data at lower energy costs compared to an example in which the processing circuits 320 are not in relatively close proximity to the data. While eight processing circuits 320 are shown, it should be appreciated that, in some embodiments, the base die 150 includes more than eight processing circuits 320 or less than eight processing circuits 320. Additionally, it should be appreciated that the processing circuits 320 can be structured similarly such that a first one of the processing circuits 320 has first hardware and/or software and a second one of the processing circuits 320 has the first hardware and/or software. It is also to be appreciated that the processing circuits 320 may be different such that the first one of the processing circuits 320 has the first hardware and/or software and the second one of the processing circuits 320 has second hardware and/or software.

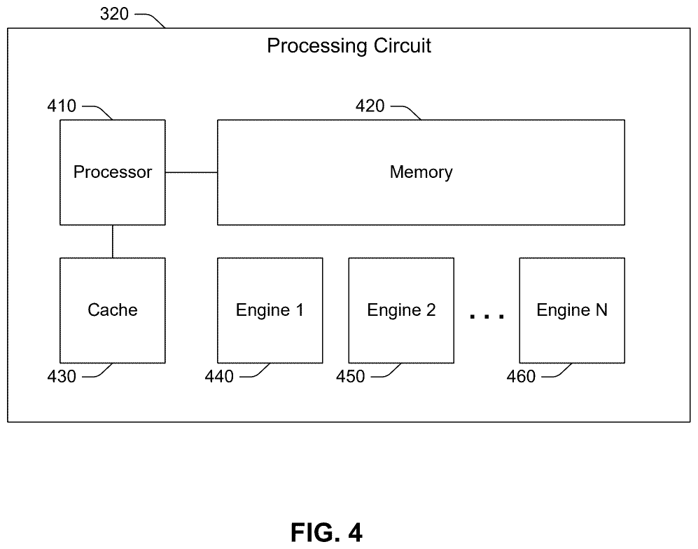

FIG. 4 illustrates a processing circuit 320, according to embodiments of the disclosure. As shown in FIG. 4, a processing circuit 320 includes a processor 410 and a memory 420. In some embodiments, the processing circuit 320 may include a cache 430 as well as engines 440, 450, 460. The processor 410 is representative of a variety of types of processors such as CPUs, accelerators, GPUs, NPUs, TPUs, etc. In some embodiments, the processor 410 includes multiple processors which may be different types of processors (e.g., a GPU, an NPU, and/or a TPU). In general, the processor 410 is configured to execute instructions which may be included in the memory 420, the cache 430, and/or an additional memory/cache. Accordingly, in some embodiments, the processor 410 is connected to the memory 420, the cache 430, and/or the additional memory/cache. Executing the instructions may cause the processor 410 to perform one or more operations (e.g., operations used in training the generative large language model 160, operations used in inference using the generative large language model 160, etc.).

The memory 420 can include volatile memory and/or non-volatile memory. In some embodiments, the memory 420 includes tightly coupled memory (TCM) which may be a nearest or fastest memory accessible to the processing circuit 320. In some embodiments, the memory 420 may be SRAM. The memory 420 may be private to the processing circuit 320 (e.g., not accessible to other processing circuits 320) or the memory 420 may be accessible to a processor outside of the processing circuit 320 such as a processor included in an additional processing circuit 320 on the base die 150.

It should be appreciated that, in some embodiments, the memory 420 can be partitioned such that a first portion of the memory 420 is private to the processing circuit 320 and a second portion of the memory 420 is accessible to other processing circuits 320. For instance, the first portion of the memory 420 that is private to the processing circuit 320 may not be used by the other processing circuits 320 (e.g., the other processing circuits 320 may not read from or write to the first portion of the memory 420). In some embodiments, the second portion of the memory 420 that is accessible to the other processing circuits 320 may be used by the other processing circuits 320 (e.g., the other processing circuits 320 can read from and write to the second portion of the memory 420).

In some embodiments, the engines 440, 450, 460 include compute engines (e.g., co-processors, logic blocks, arithmetic units, etc.) which may be configured to execute particular instructions or perform specialized operations. For example, the engines 440, 450, 460 may include cryptographic engines, compression engines, video processing engines, database processing engines, graphics engines, gaming engines, domain specific engines, etc. In some embodiments, the engine 440 includes a general matrix multiply engine and the engine 450 includes a math engine. The general matrix multiply engine can be configured for matrix-to-matrix multiplication acceleration and the math engine may be configured to process element-wise operations on floating point numbers (e.g., including basic math, exponentiation, and trigonometric functions).

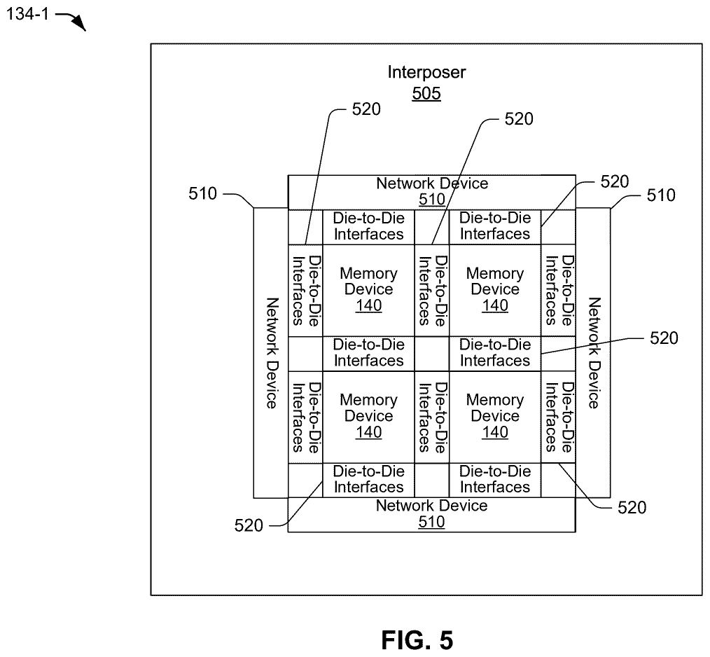

FIG. 5 illustrates an example of a first set of resources 134-1, according to embodiments of the disclosure. The first set of resources 134-1 may be included in the resources 134. In some embodiments, the resources 134 include multiple instances of the first set of resources 134-1. As depicted in FIG. 5, a first set of resources 134-1 may include one or more interposers 505, one or more memory devices 140, one or more network devices 510, and one or more die-to-die interfaces 520. The interposers 505 (e.g., silicon interposers) may be configured to communicatively couple some portions of the first set of resources 134-1 to other portions of the first set of resources 134-1.

In some embodiments, one or more interposers 505 may be configured to connect the first set of resources 134-1 with another first set of resources 134-1 or multiple other first sets of resources 134-1. Accordingly, the interposers 505 can comprise multiple smaller interposers 505 and the interposers 505 may be combined into larger interposers 505 (e.g., having a larger effective/functional area). For instance, one or more interposers 505 may represent or include bridges (e.g., silicon bridges), substrates, connection circuitry, package substrates, etc.

In the example shown in FIG. 5, the memory devices 140 are connected to the network devices 510 by die-to-die interfaces 520. Also, the memory devices 140 are illustrated to be connected to other memory devices 140 by die-to-die interfaces 520. In some embodiments, die-to-die interfaces 520 include one or more connections. For example, die-to-die interfaces 520 may include pairs of connected die-to-die interfaces 310 which may be connected by an interposer 505 in some embodiments (e.g., the interposer 505 may include a bridge that connects the die-to-die interfaces 310). For instance, die-to-die interfaces 520 may include a first die-to-die interface 310 of a memory device 140 and a second die-to-die interface 310 of a network device 510 or a second die-to-die interface 310 of another memory device 140. In some embodiments, die-to-die interfaces 520 can include various types of connections which are not limited to pairs of connected die-to-die interfaces 310.

In some embodiments, the network devices 510 may be configured to communicatively couple various devices/components in a network-based architecture (e.g., using links/interfaces). For instance, a network device 510 may be structured similarly to (or the same as) the network on chip 315 described above. In some embodiments, the network devices 510 may be configured to connect the first set of resources 134-1 to one or more additional memory devices 140, one or more additional first sets of resources 134-1, various other systems/devices included in the resources 134, etc.

In the first set of resources 134-1 shown in FIG. 5, the memory devices 140 are connected to the other memory devices 140 by die-to-die interfaces 520. In some embodiments, the memory devices 140 are connected in a mesh network such that each memory device 140 is connected to every other memory device 140 included in the first set of resources 134-1. In these embodiments, the memory devices 140 may directly communicate with neighboring/adjacent memory devices 140 in all directions. By leveraging the mesh network, a first memory device 140 may access memory and/or compute resources of a second memory device 140 in addition or alternative to memory and/or compute resources of the first memory device 140 in an efficient manner.

It should be appreciated that, in some embodiments, the memory devices 140 include both memory resources (e.g., the memory 202) and compute resources (e.g., the processing circuits 320). Accordingly, the first set of resources 134-1 is capable of performing operations that are compute intensive (e.g., generating a representation of a user input to the generative large language model 160 as one or more tokens). The first set of resources 134-1 is also capable of performing operations that are memory intensive (e.g., iteratively generating outputs from the generative large language model 160 based on a representation of a user input).

Although FIG. 5 depicts four memory devices 140 that each include four die-to-die interfaces 310, it should be appreciated that the first set of resources 134-1 may include any number of memory devices 140 which can each include any number of die-to-die interfaces 310. Additionally, while FIG. 5 illustrates two memory devices 140 in each of two rows, in some embodiments, the first set of resources 134-1 includes memory devices 140 in other array-like arrangements, for example: two memory devices 140 in a 1×2 matrix, nine memory devices 140 in a 3×3 matrix, 16 memory devices 140 in a 4×4 matrix, etc. Additionally, while the memory devices 140 are illustrated in FIG. 5 to be the same or similar (e.g., a homogeneous system), in some embodiments, a first one of the memory devices 140 can be different from a second one of the memory devices 140. For example, the first and second ones of the memory devices 140 can have different processing capabilities, different memory capabilities, different interface capabilities, etc.

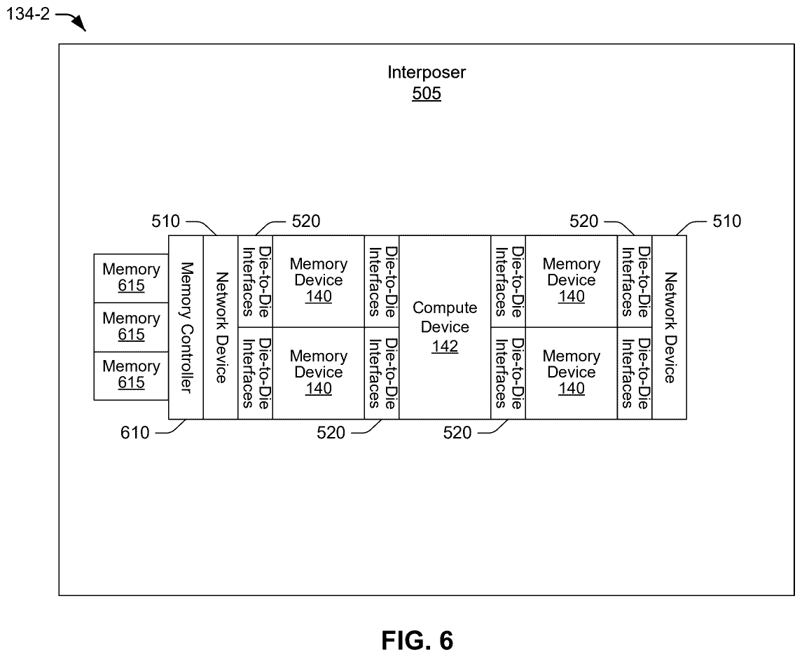

FIG. 6 illustrates an example of a second set of resources 134-2, according to embodiments of the disclosure. The second set of resources 134-2 may be included in the resources 134. In some embodiments, the resources 134 include multiple instances of the second set of resources 134-2. As depicted in FIG. 6, a second set of resources 134-2 may include one or more interposers 505, one or more memory devices 140, one or more compute devices 142, one or more network devices 510, one or more die-to-die interfaces 520, one or more memory controllers 610, and one or more memories 615. In the example shown, the memory devices 140 are connected to the network devices 510 by die-to-die interfaces 520 and the memory devices 140 are also connected to a compute device 142 by die-to-die interfaces 520.

In general, the compute device 142 may be configured to manage/control operations of the second set of resources 134-2. In some embodiments, the compute device 142 includes one or more processors such as CPUs, accelerators, GPUs, NPUs, TPUs, etc. For instance, the compute device 142 may have greater processing/computing capacity than processing circuits 320 included in the base die 150 of the memory devices 140. In some embodiments, the compute device 142 includes the functionality of the second controller 340 which the compute device 142 uses to control the processing circuits 320 included in the memory devices 140.

As illustrated in FIG. 6, a network device 510 may be configured to interface with one or more memory modules such as a memory controller 610. In the illustrated example, the memory controller 610 is communicatively coupled to one or more memories 615. The memories 615 can include volatile memory and/or non-volatile memory. In some embodiments, the memory controller 610 may include a low-power double data rate (LPDDR) memory controller and the one or more memories 615 may include one or more LPDDR memories, e.g., to expand memory resources of the memory die 155 of the memory devices 140. For instance, the memories 615 can provide additional memory resources to supplement memory resources of the memory 202 of the memory die 155 used by the base die 150.

In some embodiments, the memory 202 and the memories 615 may form faster and slower tiers, respectively, of a tiered memory system. In specific applications, the memories 615 may be used for prefetching relatively large amounts of data such as a portion of a machine learning model (e.g., portions the model layers 170 of the generative large language model 160). In a machine learning example, layer-by-layer data swapping from the memories 615 to the memory 202 may be performed to minimize latency (e.g., during a model inference).

It should be appreciated that, in some embodiments, differences between the first set of resources 134-1 and the second set of resources 134-2 may correspond to differences in compute/memory consumption and/or end-to-end latency when the first and second sets of resources 134-1, 134-2 are implemented to perform similar operations. In some embodiments, the first set of resources 134-1 may be capable of accessing memory (e.g., the memory 202) with less delay/latency than the second set of resources 134-2. In these embodiments, the memory 202 may be accessible with less delay/latency than the memories 615. For example, a memory 202 may be accessible to a processing circuit 320 in the first set of resources 134-1 more quickly (e.g., in less time) than a memory 615 (e.g., or a memory 202) is accessible to the compute device 142 in the second set of resources 134-2.

In some embodiments, the second set of resources 134-2 may be capable of executing instructions with less delay/latency than the first set of resources 134-1. In these embodiments, the compute device 142 includes greater computing/processing capacity than the processing circuits 320 in the memory devices 140 of the first set of resources 134-1. It is to be appreciated that, in some embodiments, the second set of resources 134-2 can include multiple compute devices 142 which may further increase computing/processing capacity of the second set of resources 134-2 relative to the first set of resources 134-1.

Although FIG. 6 depicts four memory devices 140 that each include two die-to-die interfaces 310, it should be appreciated that the second set of resources 134-2 may include any number of memory devices 140 which can each include any number of die-to-die interfaces 310. Additionally, while FIG. 6 illustrates two memory devices 140 in each of two rows, in some embodiments, the second set of resources 134-2 includes memory devices 140 in other arrangements. For example, the other arrangements may include six memory devices 140, eight memory devices 140, 16 memory devices 140, etc. Further, while the memory devices 140 are illustrated in FIG. 6 to be the same or similar, in some embodiments, a first one of the memory devices 140 can be different from a second one of the memory devices 140.

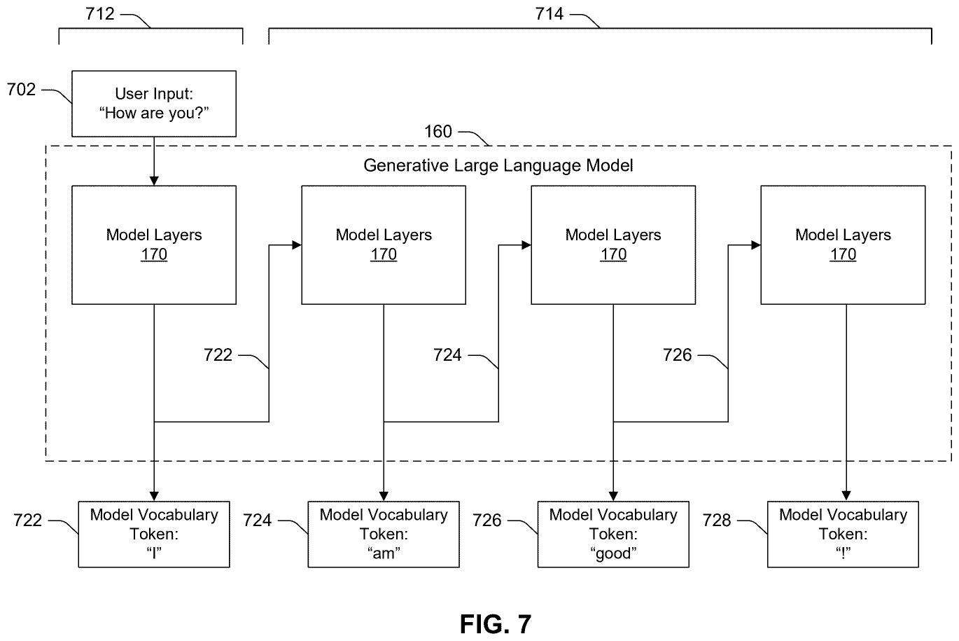

FIG. 7 illustrates a representation of tokens computed based on a user input 702 to a generative large language model 160, according to embodiments of the disclosure. In some embodiments, the generative large language model 160 includes a transformer-based model; however, the generative large language model 160 is not limited to any particular model architecture. In the example depicted in FIG. 7, the user input 702 is a natural language question stating “how are you?” As shown, the generative large language model 160 is implemented (e.g., by the resources 134) to perform operations that include processing the user input 702 in a first phase 712 and a second phase 714.

The first phase 712 is also referred to as a “prefill” phase or a “summarization” phase because during the first phase 712, the user input 702 is processed by the model layers 170 to generate a representation of the user input 702. Generally, the representation of the user input 702 is an indication of the user input 702 in a format processable by the generative large language model 160. In some embodiments, the representation of the user input 702 may include a token-based representation. For instance, a token is a discrete portion of a machine learning model input/output that typically maps between a word/character and an embedding vector in a latent space of the machine learning model. A vocabulary of the machine learning model refers to the set of all tokens and corresponding embedding vectors that the model has learned during training.

In some embodiments, during the first phase 712, a first token 722 and first context is generated for the second phase 714. As shown, the first token 722 is “I” within the model vocabulary. The first context may include data describing a variety of different information related to processing the user input 702 such as how the first token 722 is semantically related to an output to be generated by the generative large language model 160, previous user inputs to the generative large language model 160, outputs generated by the generative large language model 160 based on the previous user inputs, etc.

The second phase 714 is also referred to as a “decode” phase or a “generation” phase since the second phase 714 completes an output in iterations based on the representation of the user input 702. In a first iteration of the second phase 714, the first token 722 and the first context are processed by the model layers 170 to generate a second token 724 within the model vocabulary and second context. In the illustrated example, the second token 724 is “am.”

In a second iteration of the second phase 714, the second token 724 and the second context are processed by the model layers 170 to generate a third token 726 and third context. The third token 726 is “good” which is processed along with the third context in a third iteration of the second phase 714. In this third iteration, the model layers 170 process the third token 226 and the third context to generate a fourth token 728. As shown, the fourth token 728 is “!” which is an end token that may be indicated by fourth context generated during the third iteration of the second phase 714.

Accordingly, the complete output from the generative large language model 160 is a natural language statement of “I am good!” which is responsive to the user input 702 asking “how are you? It should be appreciated that, in some embodiments, the generative large language model 160 may be capable of generating outputs in a variety of different subject matter domains. For example, the generative large language model 160 may generate outputs that include solutions to solvable problems or templates for electronic communications. In some embodiments, the generative large language model 160 generates outputs in the different subject matter domains using subnetworks or “experts” within the model layers 170 that have learned weights corresponding to the different subject matter domains.

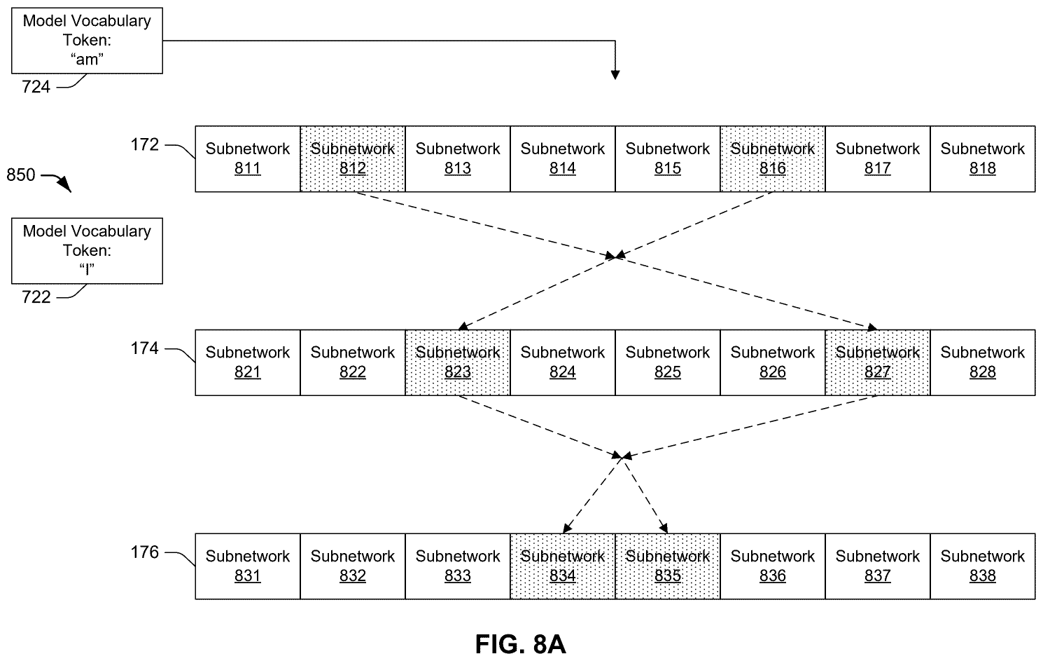

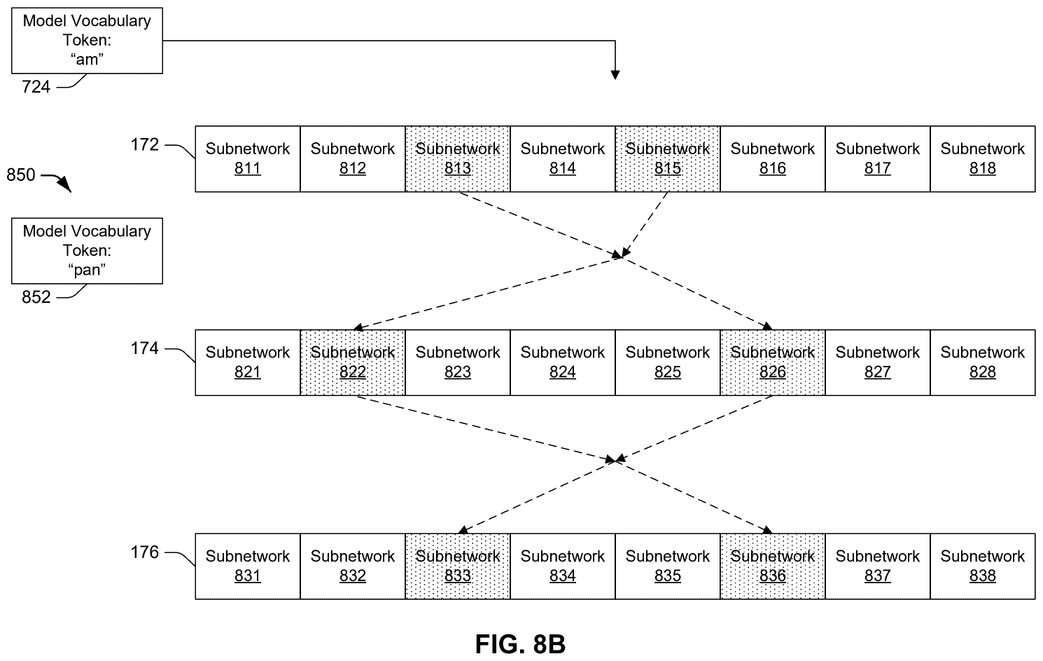

FIGS. 8A and 8B illustrate examples of identifying subnetworks within layers of a generative large language model 160, according to embodiments of the disclosure. FIG. 8A illustrates a first example of identifying subnetworks based on the second token 724 and FIG. 8B illustrates a second example of identifying subnetworks based on the second token 724. As shown, FIG. 8A includes the first layer 172, the second layer 174, and the Nth layer 176 of the model layers 170. The second token 724 is “am” as described above.

In some embodiments, subnetworks or “experts” included in the model layers 170 that are selected to process a particular token in a first instance may also be selected to process the particular token in a second instance. For example, a particular layer of the model layers 170 includes eight subnetworks or “experts” and the same two subnetworks are selected to process the particular token in both the first and second instances. In another example, two subnetworks are selected from the same four candidate subnetworks to process the particular token in both the first and second instances. In this other example, the two subnetworks are selected from the four candidate subnetworks based on one or more tokens computed before the particular token. Thus, in some embodiments, it is possible to predict which two subnetworks will be selected from the particular layer of the model layers 170 to process the particular token based on the particular token and one or more previous tokens by observing instances of subnetworks selected from the particular layer for the particular token and the one or more previous tokens.

With reference to FIG. 8A, the second token 724 is to be processed by the first layer 172, the second layer 174, and the Nth layer 176 of the generative large language model 160. For instance, a previous token 850 to the second token 724 is the first token 722 as in the example shown in FIG. 7. As shown in FIG. 8A, the first layer 172 includes subnetworks 811-818, the second layer 174 includes subnetworks 821-828, and the Nth layer 176 includes subnetworks 831-838. In some embodiments, by leveraging the previous token 850 in addition to the second token 724, it may be possible to accurately predict which of the subnetworks 811-818; 821-828; 831-838 will be selected to process the second token 724. For instance, without leveraging the previous token 850, it may not be possible to accurately predict which of the subnetworks 811-818; 821-828; 831-838 will be selected to process the second token 724.

In the illustrated example, subnetworks 812, 816 are selected from the first layer 172 to process the second token 724. It is to be appreciated that a processes/mechanism used to select the subnetworks 812, 816 from the first layer 172 may be known or unknown. For instance, the subnetworks 812, 816 may be selected using a gating function or a “router network” that computes probability scores for each of the subnetworks 811-818 and selects the subnetworks 812, 816 as having the highest probability scores. In some embodiments, the subnetwork 812 includes first weights learned during training and the subnetwork 816 includes second weights learned during training that are independent of the first weights. For instance, the subnetwork 812 may include a first multi-layer perceptron and the subnetwork 816 may include a second multi-layer perceptron.

As shown, subnetworks 823, 827 are selected from the second layer 174 to process the second token 724 and subnetworks 834, 835 are selected from the Nth layer 176 to process the second token 724. The subnetworks 823, 827, 834, 835 may be selected as described above relative to the subnetworks 812, 816. Accordingly, a portion of the generative large language model 160 that includes the subnetworks 812, 816, 823, 827, 834, 835 is selected to process the second token 724 if the previous token 850 to the second token 724 is the first token 722. It is to be appreciated that, in some embodiments, if the previous token 850 to the second token 724 is not the first token 722, then a portion of the generative large language model 160 selected to process the second token 724 may not include the subnetworks 812, 816, 823, 827, 834, 835.

With reference to FIG. 8B, the second token 724 is to be processed by the first layer 172, the second layer 174, and the Nth layer 176 of the generative large language model 160. Unlike the example shown in FIG. 8A in which the previous token 850 is the first token 722, in FIG. 8B, the previous token 850 is a different token 852 that is “pan” in the model vocabulary. As shown, subnetworks 813, 815 are selected from the first layer 172 to process the second token 724; subnetworks 822, 826 are selected from the second layer 174 to process the second token 724; and subnetworks 833, 836 are selected from the Nth layer 176 to process the second token 724. Thus, a portion of the generative large language model 160 that includes the subnetworks 813, 815, 822, 826, 833, 836 is selected to process the second token 724 if the previous token 850 to the second token 724 is the different token 852.

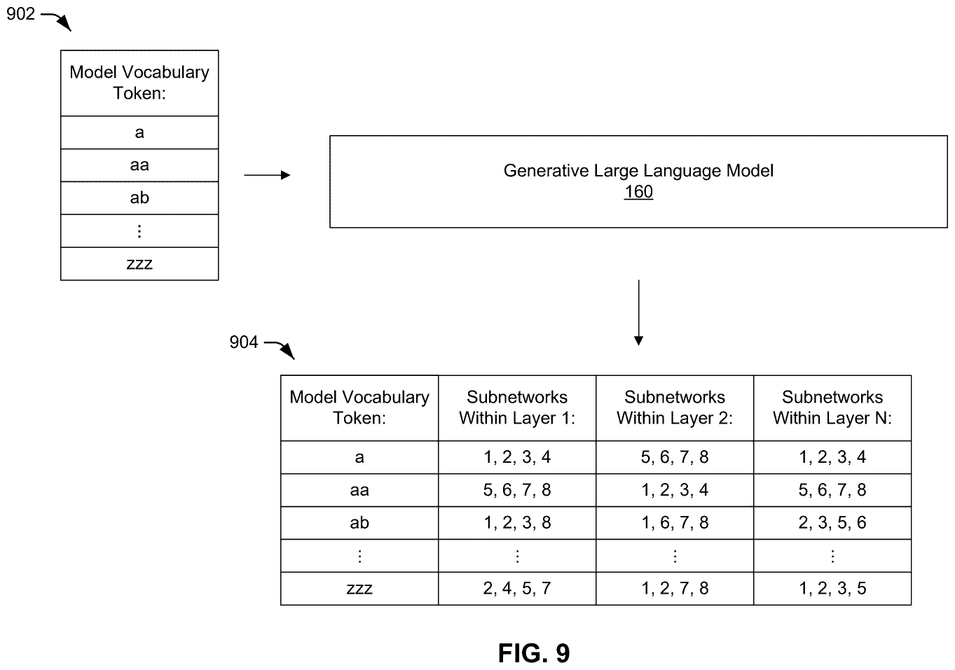

FIG. 9 illustrates a representation of determining potential subnetworks within layers of a generative large language model 160 based on tokens, according to embodiments of the disclosure. The example shown in FIG. 9 includes a first table 902, a second table 904, and the generative large language model 160. The first table 902 is illustrated to include tokens (e.g., all of the tokens) in the vocabulary of the generative large language model 160.

In some embodiments, in order to predict subnetworks that will be selected within layers of the generative large language model 160 to process the tokens included in the first table 902, each of these tokens may be processed many times using the generative large language model 160 and the subnetworks selected each time may be tracked/recorded using the second table 904. It is to be appreciated that, in some embodiments, an operator/user processes the tokens included in the first table 902 many times using the generative large language model 160 in order to generate information included in the second table 904. As shown, the second table 904 may include a top N subnetworks based on a number of times in which subnetworks within layers (e.g., 1, 2, N) were selected to process a corresponding token from the first table 902.

In the illustrated example, it is possible to identify the top N subnetworks which are likely to be selected to process the tokens in the vocabulary of the generative large language model 160 using the second table 904. Consider an example in which a subset (e.g., N/2) of the top N subnetworks within layers of the model layers 170 is selected to process the tokens included in the first table 902. In this example, identifying the top N subnetworks which are likely to be selected to process the tokens is not sufficient to determine the subset of the top N subnetworks (e.g., N/2) that is selected to process the tokens included in the first table 902. Accordingly, in this example, information included in the second table 904 may not be directly utilized to accurately identify the subset of the top N subnetworks.

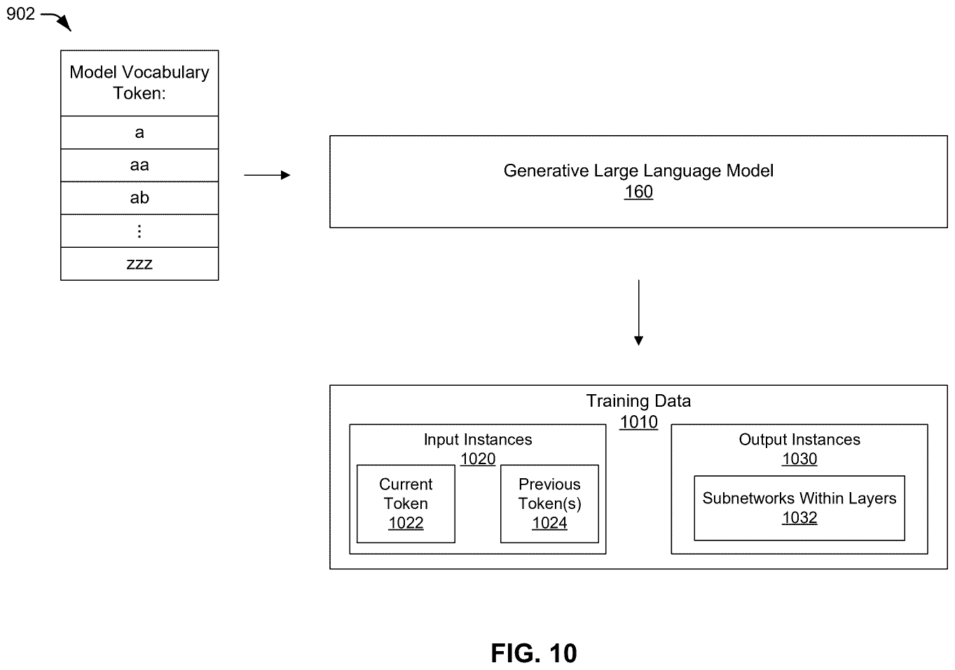

FIG. 10 illustrates a representation of generating training data 1010, according to embodiments of the disclosure. As shown, FIG. 10 depicts the first table 902 and the generative large language model 160. In addition or alternative to generating the second table 904 as described above, the generative large language model 160 can be implemented to process each of the tokens included in the first table 902 many times and the subnetworks within layers of the model layers 170 selected each time may be determined in order to generate training data 1010. It is to be appreciated that, in some embodiments, an operator/user processes the tokens included in the first table 902 many times using the generative large language model 160 in order to generate the training data 1010.

In the illustrated example, the training data 1010 includes pairs of input instances 1020 and corresponding output instances 1030. In some embodiments, the input instances 1020 include a current token 1022 and one or more previous tokens 1024 and the corresponding output instances 1030 include subnetworks within layers 1032 selected by the generative large language model 160 to process the current token 1022. By way of example relative to FIG. 8A, an input instance 1020 of the training data 1010 may include the second token 724 as a current token 1022 and the first token 722 as one or more previous tokens 1024. In this example, a corresponding output instance 1030 to the input instance 1020 may include the subnetworks 812, 816 within the first layer 172; the subnetworks 823, 827 within the second layer 174; and the subnetworks 834, 835 within the Nth layer 176 as subnetworks within layers 1032.

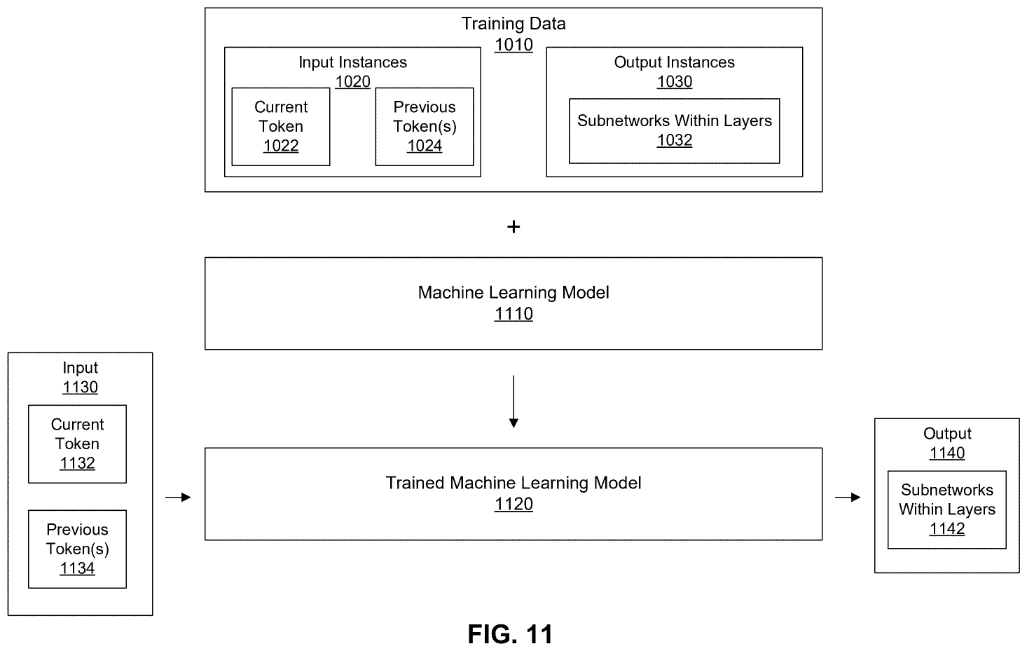

FIG. 11 illustrates a representation of training a machine learning model 1110 using training data 1010, according to embodiments of the disclosure. In some embodiments, the machine learning model 1110 is trained on pairs of input instances 1020 and corresponding output instances 1030 included in the training data 1010 to predict the output instances 1030 based on the input instances 1020. It is to be appreciated that, in some embodiments, an operator/user trains the machine learning model 1110 using training data 1010. It is to be appreciated that, in some embodiments, training the machine learning model 1110 using the training data 1010 to predict the output instances 1030 may be performed in various ways using a multitude of different loss functions. In some embodiments, the machine learning model 1110 may include a multi-layer perceptron (e.g., a three-layer multi-layer perceptron). In other embodiments, the machine learning model 1110 can include other architectures (e.g., probabilistic, tree-based, cluster-based, etc.) which may leverage various types of machine learning (e.g., semi-supervised, supervised, unsupervised, reinforcement, etc.).

As shown in FIG. 11, once trained on the training data 1010, the machine learning model 1110 may be represented as a trained machine learning model 1120. In the illustrated example, the trained machine learning model 1120 is capable of receiving an input 1130 including a current token 1132 and one or more previous tokens 1134 and generating an output 1140 that includes subnetworks within layers 1142 based on the input 1130. By way of example relative to FIG. 8A, the trained machine learning model 1120 may receive the input 1130 as including the second token 724 as a current token 1132 and the first token 722 as one or more previous tokens 1134. In this example, the trained machine learning model 1120 may generate the output 1140 as including the subnetworks 812, 816 within the first layer 172; the subnetworks 823, 827 within the second layer 174; and the subnetworks 834, 835 within the Nth layer 176 as subnetworks within layers 1142.

Consider an example in which the trained machine learning model 1120 may be leveraged to reduce latency in generating outputs with the generative large language model 160 using the resources 134. In this example, the compute devices 142 perform operations (e.g., processors included in the compute devices 142 execute instructions) using data available in one or more memories included in the memory devices 140. In order to generate outputs with the generative large language model 160, the memory devices 140 include data describing the model layers 170.

With reference to FIG. 8A, the memory devices 140 may include data describing the first layer 172 that includes each of the subnetworks 811-818. As the compute devices 142 perform operations relative to the generative large language model 160, the subnetworks 812, 816 are selected to process the second token 724. Data describing the subnetworks 812, 816 is read from the memory devices 140 and the data describing the subnetworks 812, 816 is written to a “fast memory” such as a TCM or a cache that is physically in close proximity to the compute devices 142 in order to process the second token 724. In some embodiments, latency incurred in reading the data describing the subnetworks 812, 816 from the memory devices 140 may be reduced by using the trained machine learning model 1120 to predict the subnetworks 812, 816 within the first layer 172 and then prefetching the data describing the subnetworks 812, 816 from the memory devices 140.

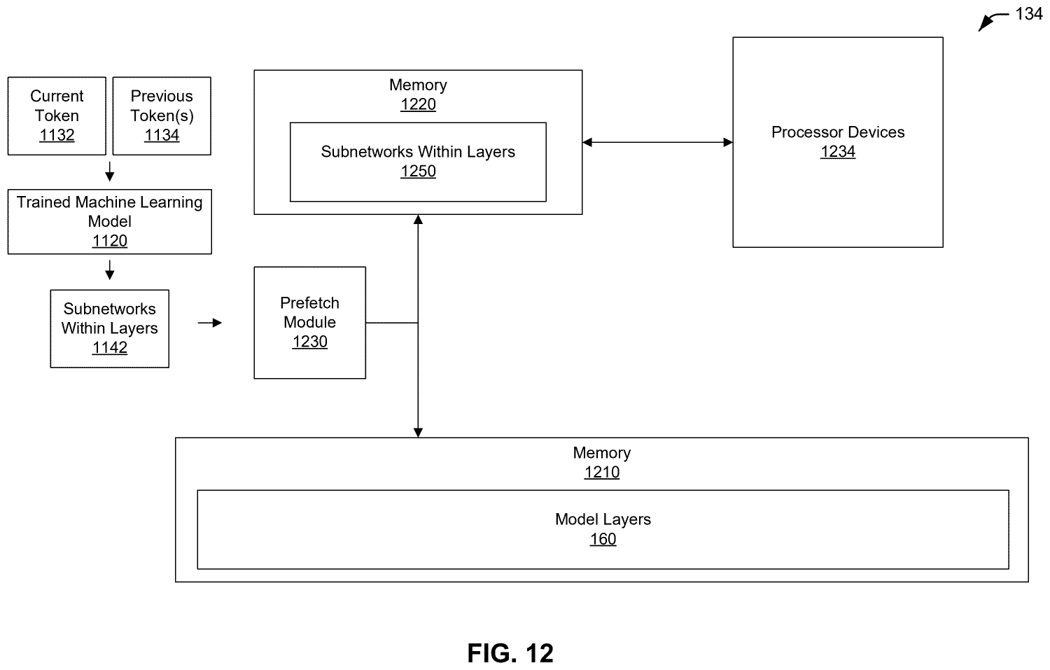

FIG. 12 illustrates a representation of prefetching a portion of a generative large language model 160, according to embodiments of the disclosure. As shown, FIG. 12 includes a representation of the resources 134 which depicts processor devices 1234. In some embodiments, the processor devices 1234 include one or more processors. It is to be appreciated that, in some embodiments, the processor devices 1234 can include the first set of resources 134-1, the second set of resources 134-2, other/additional sets of resources, etc. A first memory 1210 (e.g., of a first memory device 140) is illustrated to include data describing the model layers 170 of the generative large language model 160. A second memory 1220 (e.g., of a second memory device 140) is illustrated to be in closer proximity to the processor devices 1234 than the first memory 1210.

In some embodiments, as the generative large language model 160 processes a user input 702 in an iteration of the second phase 714, the trained machine learning model 1120 may be implemented to process a current token 1132 and one or more previous tokens 1134 corresponding to the iteration of the second phase 714. For example with respect to FIG. 8A, the trained machine learning model 1120 processes the second token 724 and the first token 722 in order to generate subnetworks within layers 1142 as including a portion (e.g., the subnetworks 812, 816) of the first layer 172, a portion (e.g., the subnetworks 823, 827) of the second layer 174, and a portion (e.g., the subnetworks 834, 835) of the Nth layer 176. For instance, the generated subnetworks within layers 1142 indicate that the trained machine learning model 1120 will select the subnetworks 812, 816, 823, 827, 834, 835 to process the second token 724 based on the first token 722 as the previous token 850.

A prefetch module 1230 (e.g., any hardware/software capable of prefetching data) prefetches data describing subnetworks within layers 1250 as including the subnetworks 812, 816 within the first layer 172; the subnetworks 823, 827 within the second layer 174; and the subnetworks 834, 835 within the Nth layer 176 from the first memory 1210. For instance, the generated subnetworks within layers 1142 identifies the subnetworks 812, 816, 823, 827, 834, 835 while the data describing subnetworks within layers 1250 includes (e.g., copies of) the subnetworks 812, 816, 823, 827, 834, 835. In some embodiments, the prefetch module 1230 writes the data describing subnetworks within layers 1250 to the second memory 1220 for processing by the processor devices 1234.

It is to be appreciated that, in some embodiments, writing the data describing subnetworks within layers 1250 to the second memory 1220 (e.g., before the data is requested by the processor devices 1234) may avoid latency incurred in reading the data describing subnetworks within layers 1250 from the first memory 1210. For instance, the generative large language model 160 may be configured to generate an output based on the user input 702 in a first amount of time when the data describing the subnetworks within layers 1250 is included in the second memory 1220 and the generative large language model 160 may be configured to generate the output based on the user input 702 in a second amount of time when the data describing the subnetworks within layers 1250 is included in the first memory 1210 (e.g., the data is read from the first memory 1210). In some embodiments, the second amount of time is greater than the first amount of time.

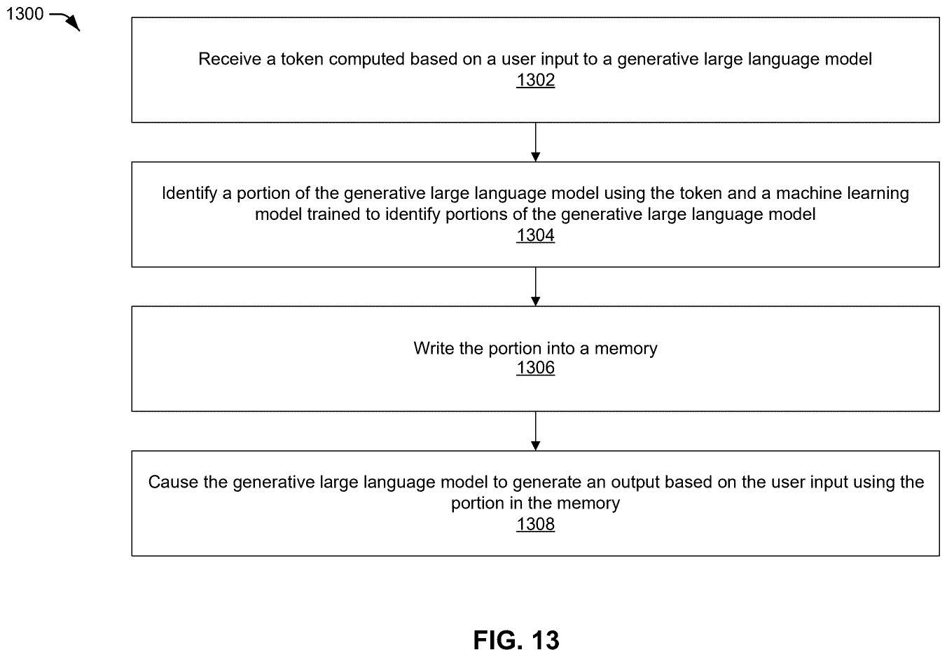

FIG. 13 shows a flowchart of an example procedure 1300 for causing a generative large language model 160 to generate an output, according to embodiments of the disclosure. At block 1302, a token computed based on a user input to a generative large language model 160 is received. In some embodiments, a compute device 142 and/or a processing circuit 320 may compute the token based on the user input. At block 1304, a portion of the generative large language model 160 is identified using the token and a machine learning model trained to identify portions of the generative large language model 160. The compute device 142 and/or the processing circuit 320 may identify the portion of the generative large language model 160. At block 1306, the portion is written into a memory. In some embodiments, the compute device 142 and/or the processing circuit 320 may write the portion into the memory. At block 1308, the generative large language model 160 is caused to generate an output based on the user input using the portion in the memory. The compute device 142 and/or the processing circuit 320 may cause the generative large language model 160 to generate the output based on the user input.

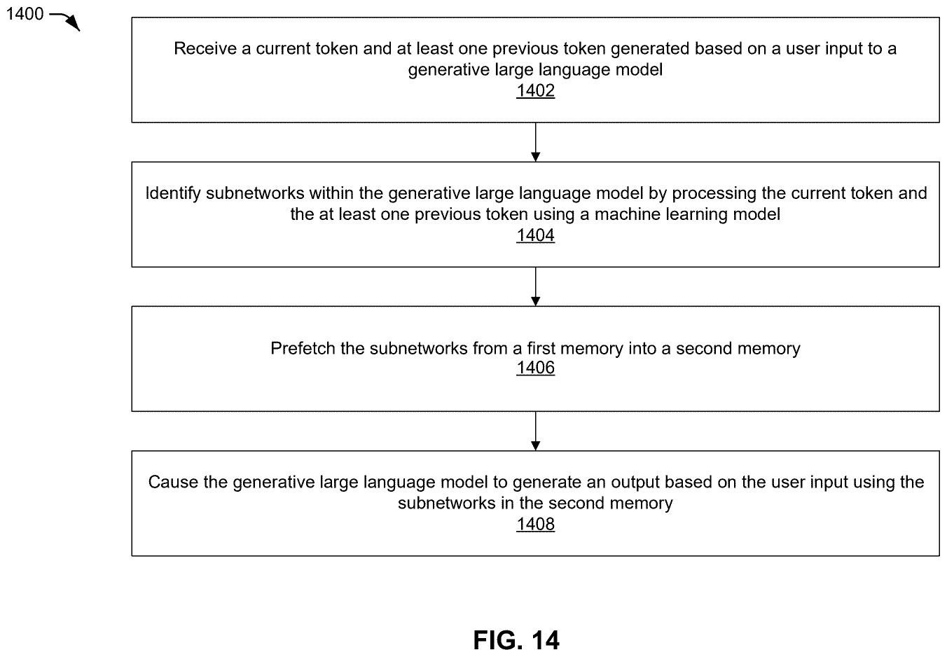

FIG. 14 shows a flowchart of an example procedure 1400 for causing a generative large language model 160 to generate an output, according to embodiments of the disclosure. At block 1402, a current token and at least one previous token generated based on a user input to a generative large language model 160 are received. In some embodiments, a first set of resources 134-1 and/or a second set of resources 134-2 generates the current token and the at least one previous token based on the user input. At block 1404, subnetworks within the generative large language model 160 are identified by processing the current token and the at least one previous token using a machine learning model. The first set of resources 134-1 and/or the second set of resources 134-2 may identify the subnetworks within the generative large language model 160. At block 1406, the subnetworks are prefetched from a first memory into a second memory. In some embodiments, the first set of resources 134-1 and/or the second set of resources 134-2 prefetches the subnetworks from the first memory into the second memory. At block 1408, the generative large language model 160 is caused to generate an output based on the user input using the subnetworks in the second memory. The first set of resources 134-1 and/or the second set of resources 134-2 may cause the generative large language model 160 to generate the output based on the user input.

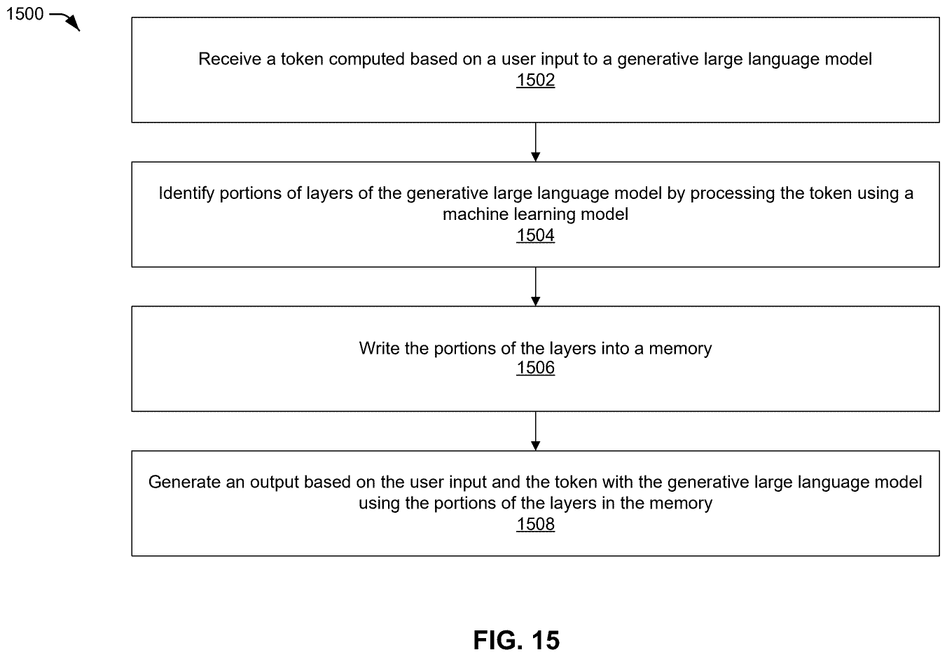

FIG. 15 shows a flowchart of an example procedure 1500 for generating an output with a generative large language model 160, according to embodiments of the disclosure. At block 1502, a token computed based on a user input to a generative large language model 160 is received. In some embodiments, one or more memory devices 142 compute the token based on the user input. At block 1504, portions of layers of the generative large language model 160 are identified by processing the token using a machine learning model. One or more memory devices 142 may identify the portions of the layers. At block 1506, the portions of the layers are written into a memory. In some embodiments, one or more memory devices 142 write the portions of the layers into the memory. At block 1508, an output is generated based on the user input and the token with the generative large language model 160 using the portions of the layers in the memory. One or more memory devices 142 may generate the output based on the user input and the token with the generative large language model 160.

In FIGS. 13-15, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, application specific integrated circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., random access memory (RAM), read only memory (ROM), etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium (e.g., a computer-readable storage medium) comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in random access memory (RAM), flash memory, read only memory (ROM), electrically programmable ROM (EPROM), electrically erasable programmable ROM (EEPROM), registers, hard disk, a removable disk, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A method comprising:
receiving a token computed based on a user input to a generative large language model;
identifying a portion of the generative large language model using the token and a machine learning model trained to identify portions of the generative large language model;
writing the portion into a memory; and
causing the generative large language model to generate an output based on the user input using the portion in the memory.

2. The method according to claim 1, wherein the portion comprises a first subnetwork within a first layer of the generative large language model and a second subnetwork within a second layer of the generative large language model.

3. The method according to claim 2, wherein the portion further comprises a third subnetwork within the first layer of the generative large language model and a fourth subnetwork within the second layer of the generative large language model.

4. The method according to claim 3, wherein the first subnetwork comprises first weights and the third subnetwork comprises second weights that are independent of the first weights.

5. The method according to claim 2, wherein the first subnetwork comprises a multi-layer perceptron.

6. The method according to claim 1, wherein the machine learning model is trained on training data describing input instances comprising a current token and at least one previous token and corresponding output instances comprising subnetworks within layers of the generative large language model.

7. The method according to claim 1, wherein the memory is included in at least one memory die attached to a base die.

8. A system comprising:
a first memory;
a second memory; and
a processor coupled to the first memory and the second memory, the processor configured to:
receive a current token and at least one previous token generated based on a user input to a generative large language model;
identify subnetworks within the generative large language model by processing the current token and the at least one previous token using a machine learning model;
prefetch the subnetworks from the first memory into the second memory; and
cause the generative large language model to generate an output based on the user input using the subnetworks in the second memory.

9. The system according to claim 8, wherein the subnetworks comprise a first subnetwork within a first layer of the generative large language model and a second subnetwork within the first layer of the generative large language model.

10. The system according to claim 9, wherein the first layer of the generative large language model comprises a third subnetwork and a fourth subnetwork.

11. The system according to claim 9, wherein first subnetwork comprises first weights and the second subnetwork comprises second weights that are independent of the first weights.

12. The system according to claim 8, wherein the second memory is included in at least one memory die attached to a base die.

13. The system according to claim 8, wherein the first memory comprises a low-power double data rate (LPDDR) memory.

14. The system according to claim 13, wherein the first memory is connected to a LPDDR memory controller that is connected to a compute device.

15. The system according to claim 8, wherein the generative large language model is configured to generate the output using the subnetworks in the second memory in a first amount of time and the generative large language model is configured to generate the output using the subnetworks in the first memory in a second amount of time that is greater than the first amount of time.

16. A non-transitory computer-readable storage medium storing instructions that, responsive to execution by a processor, cause the processor to perform operations comprising:
receiving a token computed based on a user input to a generative large language model;
identifying portions of layers of the generative large language model by processing the token using a machine learning model;
writing the portions of the layers into a memory; and
generating an output based on the user input and the token with the generative large language model using the portions of the layers in the memory.

17. The non-transitory computer-readable storage medium according to claim 16, wherein a first portion of the portions of the layers comprises first weights and a second portion of the portions of the layers comprises second weights that are independent of the first weights.

18. The non-transitory computer-readable storage medium according to claim 16, wherein the portions of the layers comprise subnetworks of the layers.

19. The non-transitory computer-readable storage medium according to claim 16, wherein the machine learning model is trained on training data describing input instances comprising a current token and at least one previous token and corresponding output instances comprising subnetworks within the layers of the generative large language model.

20. The non-transitory computer-readable storage medium according to claim 16, wherein the memory is included in at least one memory die attached to a base die.
